(19) United States
(12) Patent Application Publication
(10) Pub. No.: US 2026/0368830 A1
(43) Pub. Date: Nov. 19, 2026

(54) MULTI-LAYER HEALTHCARE CLAIM DENIAL INTELLIGENCE WITH A CLIENT-SIDE ADDITIVE BASELINE-NEUTRAL SCORING ENGINE, A PAYER-TRANSPARENCY-DATA-DERIVED MULTIPLICATIVE MODIFIER, AND CONSTRAINED LARGE-LANGUAGE-MODEL REMEDIATION OUTPUT

(71) Applicants: Griffin Katz, La Jolla, CA (US); Zach Katz, Dallas, TX (US)

(72) Inventors: Griffin Katz, La Jolla, CA (US); Zach Katz, Dallas, TX (US)

(73) Assignee: Precertif.ai LLC, Dallas, TX (US)

(21) Appl. No.: 19/755,759

(22) Filed: Jul. 27, 2026

Related U.S. Application Data
(60) Provisional application No. 64/052,841, filed on Apr. 29, 2026.

(51) Int. Cl. G06Q 40/08; G06V 10/77

(52) U.S. Cl. CPC G06Q 40/0841; G06V 10/7715

(57) ABSTRACT

A multi-layer claim denial intelligence platform operates in pre-submission and post-denial modes. A client device locally computes a structural denial-risk score by additively combining a baseline with signed point contributions of intrinsic claim factors, without transmitting claim-identifying parameters to a server; unknown inputs contribute zero points, so the score is computable from any single input. A server compiles a lookup table from publicly published issuer-level payer-transparency data, storing data-source and vintage identifiers, and supplies an issuer-specific multiplicative payer modifier. A deterministic layer performs NCCI edit-conflict detection and prior-authorization lookup. Upon explicit user action, a large language model is invoked under a grounding directive, a structured-output directive, and an output-length constraint derived from a gateway timeout budget, and any model-proposed score adjustment is server-clamped so the model cannot override deterministic results. Outputs include remediation checklists with risk-if-skipped assessments and appeal materials with immutable legal skeletons.

### CROSS-REFERENCE TO RELATED APPLICATIONS

This application claims the benefit of U.S. Provisional Application No. 64/052,841, filed Apr. 29, 2026, and entitled “SYSTEMS AND METHODS FOR MULTI-LAYER HEALTHCARE CLAIM DENIAL INTELLIGENCE USING AN ADDITIVE STRUCTURAL SCORING ENGINE WITH A CMS-PUBLIC-DATA-DERIVED MULTIPLICATIVE PAYER MODIFIER, LLM-GENERATED PRE-SUBMISSION REMEDIATION CHECKLISTS WITH PER-ITEM RISK-IF-SKIPPED ASSESSMENTS, AND DUAL-MODE OPERATION FOR PRE-SUBMISSION DENIAL PREVENTION AND POST-DENIAL APPEAL VIABILITY SCORING,” the entire disclosure of which is hereby incorporated by reference herein.

### STATEMENT REGARDING FEDERALLY SPONSORED RESEARCH OR DEVELOPMENT

Not applicable.

### COPYRIGHT AND TRADEMARK NOTICE

A portion of the disclosure of this patent document may contain material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever. Any third-party names, marks, standards designations, or product identifiers referenced herein (including, without limitation, HL7, FHIR, SMART, CDS Hooks, CQL, NCPDP, and the names of any payer, cloud provider, or model provider) are the property of their respective owners, are used solely for identification and as non-limiting examples, and where a generic term exists the generic term is intended.

### TECHNICAL FIELD

The present disclosure relates to healthcare information technology and, more specifically, to computer-implemented systems and methods for (i) automated, public-data-grounded pre-submission claim denial risk scoring using a multi-layer architecture combining a client-side additive structural scoring engine, a server-side multiplicative payer modifier derived from publicly published payer-transparency data, a server-side deterministic analysis layer, and a large-language-model reasoning layer; (ii) post-denial appeal viability scoring using real issuer-level payer-transparency data; (iii) consumer-facing post-denial appeal generation from patient-uploaded Explanation-of-Benefits (“EOB”) documents; (iv) pharmacy-benefit prior-authorization decision support; (v) closed-loop outcome-feedback learning from real-world appeal dispositions; and (vi) integration with FHIR-based Prior Authorization Requirements Discovery / Documentation/Decision (“PARDD”) interoperability infrastructure, CDS-Hooks, and SMART-on-FHIR.

### BACKGROUND

Healthcare claim denials—both pre-submission (“will my claim be denied if I submit it as constructed?”) and post-submission (“how do I appeal a denied claim?”)—represent an acute economic and clinical burden. Published analyses of Healthcare. gov Marketplace claims indicate that fewer than 1% of denied claims are appealed despite appellant success rates of approximately 40-50%. The American Medical Association reports that physicians and office staff spend approximately 13 hours per week on prior-authorization tasks alone. These figures describe the operating environment of the disclosed technology; the problems addressed by the present disclosure, however, are technical problems in the construction of computing systems that operate in that environment, as set out in paragraphs [0007]-[0010] below.

The Centers for Medicare & Medicaid Services (“CMS”) published the Interoperability and Prior Authorization Final Rule (CMS-0057-F, 89 Fed. Reg. 8758 (Feb. 8, 2024)), requiring Medicare Advantage organizations, Medicaid/CHIP fee-for-service and managed care organizations, and qualified-health-plan issuers on the Federally-Facilitated Exchanges to implement a Prior Authorization API built to HL7 FHIR R4, to publish prior-authorization metrics annually (first public metrics deadline Mar. 31, 2026), to implement 72-hour expedited and 7-calendar-day standard decision timeframes, and to provide specific denial reasons electronically. CMS subsequently proposed CMS-0062-P (published Apr. 14, 2026), which would extend FHIR-based prior authorization to medical-benefit drugs and would require electronic pharmacy-benefit standards of a national pharmacy-standards organization beginning Oct. 1, 2027. These regulatory developments make machine-readable, issuer-level payer performance data publicly available on a recurring schedule, and make machine-mediated prior-authorization transactions an anticipated interoperability surface.

A first technical problem addressed herein concerns machine-learned denial-prediction models. A denial scorer built by supervised training requires a large proprietary corpus of historical adjudicated claims before it can produce any useful output; absent such a corpus the model exhibits a cold-start failure in which no reliable score can be produced at all. Trained models are additionally opaque—their score cannot be decomposed into auditable per-input contributions—and they drift as payer behavior changes, requiring recurring retraining pipelines, labeled-data governance, and model-monitoring infrastructure. A further failure mode arises on sparse input: a trained model presented with only one or two known claim attributes either refuses to score or produces a score dominated by imputation artifacts, misleading the user. There is accordingly a need for a scoring architecture that produces a decomposable, auditable score from any single available input, without any training corpus, and that incorporates payer-specific behavior from data that is published, versioned, and refreshable rather than learned.

A second technical problem concerns where scoring computation executes. Architectures that transmit claim parameters to a server for scoring incur two costs: (a) a data-exposure cost, because claim parameters—which may include or imply protected health information—must traverse a network and be processed and potentially logged by server infrastructure even for exploratory “what-if” scoring; and (b) a latency and availability cost, because every keystroke-level rescore requires a network round trip and a healthy server. There is a need for a computational boundary in which the structural portion of the score is computed entirely at the client device, without transmitting claim parameters to any server, and in which server-side resources are engaged only upon an explicit user action.

A third technical problem concerns the use of generative large language models within latency-bounded, correctness-sensitive pipelines. Unconstrained generative output is unbounded in length and therefore unbounded in generation latency, which conflicts with fixed timeout budgets imposed by intermediary API gateways; unconstrained output is frequently unparseable by downstream software; and an unconstrained model may hallucinate payer policies, portal names, coverage-determination identifiers, or regulatory citations that do not exist, injecting fabricated facts into clinical-administrative workflows. There is a need for an output contract that (a) bounds generation length as a function of the gateway timeout budget, (b) forces output into a structured machine-readable schema, (c) grounds generation exclusively in supplied deterministic data, and (d) structurally prevents the generative component from overriding deterministic scoring outputs.

A fourth technical problem concerns automated document understanding feeding automated document generation. Optical-character-recognition and vision-model extraction of fields from scanned or photographed benefit documents is error-prone, and an extraction error—a transposed claim number, a misread reason code, a wrong deadline—propagates directly into downstream legal documents such as appeal letters, where the error carries legal consequence. There is a need for an extraction pipeline with per-field confidence semantics, deterministic cross-validation of extracted codes against locally stored reference databases, user-confirmation flagging of low-confidence fields, and a generation-control mechanism that guarantees that legally operative template regions survive machine personalization unmodified.

The architecture disclosed herein addresses these technical problems in combination. Nothing in this Background is an admission that any particular approach, publication, or product is prior art to the claims, nor an admission regarding the content of any prior art.

### SUMMARY

Disclosed herein are systems, methods, and non-transitory computer-readable media implementing a multi-layer claim denial intelligence platform operating in two modes sharing a common scoring engine: (A) a pre-submission “Predict and Prevent” mode that scores denial risk before claim submission and generates ordered remediation checklists; and (B) a post-denial “Dispute a Denial” mode that scores existing denials for appeal viability using real issuer-level payer-transparency data.

In a first aspect, a computer-implemented method for pre-submission healthcare claim denial-risk scoring comprises: computing, by a client device executing a client-side, stateless denial scoring engine, and without transmitting claim parameters of a healthcare claim to a server, a structural score for the healthcare claim using an additive baseline-neutral model that begins at a baseline value and adds a respective factor contribution for each of at least twelve intrinsic factors, each factor contribution being retrieved by table lookup from a factor point table and the structural score being computed without generating any learned embedding of the claim parameters and without applying, at scoring time, any neural network or other machine-learning model trained on historical claim-outcome labels, wherein an unknown or missing input contributes a zero factor contribution at the baseline-neutral position such that the structural score is computable from any single available input, and wherein the structural score is clipped to a bounded range; retrieving, from a server-side scoring lookup table compiled from publicly published issuer-level payer-transparency data, an issuer-specific payer modifier derived from at least an issuer-level plan denial rate and an issuer-level appeal overturn rate; applying the payer modifier as a multiplicative adjustment to the structural score to produce a final score clipped to the bounded range; assigning the final score to one band of a predetermined set of bands; performing, by a server-side deterministic analysis engine, at least National Correct Coding Initiative (“NCCI”) edit-conflict detection and per-procedure-code per-payer prior-authorization-requirement lookup, and computing therefrom a denial probability; responsive to an explicit user action received after the structural score is displayed, submitting to a large language model a prompt comprising the deterministic layer outputs and clinician-provided structured inputs, the prompt including a grounding directive, a structured-output directive, and a length constraint bounding output to complete within a timeout budget of an intermediary gateway; receiving a structured response comprising a diagnosis-code specificity recommendation and an ordered checklist of pre-submission remediation items each carrying a priority level and a risk-if-skipped assessment; and outputting the final score, band, denial probability, and checklist for display at the client device.

In a second aspect, a computer-implemented method for post-denial appeal-viability scoring comprises: receiving claim parameters of an existing denied healthcare claim including at least an issuer identifier, a claim-adjustment-reason code (“CARC”), a procedure code, a billed amount, a state identifier, a network status, an emergency status, a prior-authorization status, and a number of days since denial; computing a structural score using the additive baseline-neutral denial scoring engine, each factor contribution being retrieved by table lookup from a factor point table and the structural score being computed without applying, at scoring time, any neural network or other machine-learning model trained on historical claim-outcome labels; retrieving from the scoring lookup table an issuer-specific payer modifier, plan denial rate, and appeal overturn rate; computing a final appeal-viability score by multiplicative adjustment and clipping; assigning a band; and outputting the final score, band, plan denial rate, appeal overturn rate, a per-factor decomposition identifying the factor contribution of each intrinsic factor, an identification of any triggered cross-factor interaction, and at least one warning flag, wherein the structural score and the payer modifier are output as separate fields enabling independent display of the contribution of each scoring stage.

In a third aspect, a consumer-facing post-denial pipeline comprises: receiving an EOB document uploaded by a patient in an image or portable-document format; extracting, via a vision-enabled machine-learning model, a plurality of structured fields each assigned a per-field confidence score, with a null value emitted for any field that cannot be confidently identified; cross-validating each extracted code against at least one locally stored code-reference database; flagging for user confirmation any field whose confidence falls below a threshold or whose cross-validation fails; computing an appeal-viability score; generating an ordered recovery playbook personalized with a telephone script, a payer contact record, and an evidence checklist; selecting an appeal-letter template from a template set based on the CARC code; and generating an appeal-letter document by personalizing designated narrative fields of the selected template via a large language model while preserving unmodified legal-skeleton portions of the template, including regulatory citations selected according to the line of business of the denied claim.

In a fourth aspect, a dual-mode system comprises one or more processors and memories storing instructions to provide a shared denial scoring engine operable in the pre-submission mode and the post-denial mode; maintain the scoring lookup table compiled from publicly published issuer-level payer-transparency data; execute the deterministic analysis engine; and submit, upon explicit user invocation, a grounded, length-constrained prompt to a large language model. In some embodiments the shared engine executes client-side within a web browser without server communication, and a server-side token-proxy function resolves a browser cross-origin restriction by proxying an authentication-token request and returning a token with cross-origin response headers.

In a fifth aspect, a closed-loop outcome-feedback process records, for scored claims, outcome labels selected from approved, partially approved, denied, and withdrawn, together with time-to-disposition and final allowed amount; retrains, by Bayesian hierarchical logistic regression with shrinkage applied to sparse cells, coefficients comprising at least a per-CARC factor, a per-payer factor, and a per-state factor; applies retrained coefficients to the scoring lookup table as versioned weight records; and requires human-in-the-loop review before deployment when a retrained-coefficient shift exceeds a threshold magnitude.

In a sixth aspect, a pharmacy-benefit embodiment adapts the scoring layers to electronic prescribing, formulary-and-benefit, and real-time prescription-benefit standards of a national pharmacy-standards organization, wherein at least one checklist item references a pharmacy-claim reject code indicating that prior authorization is required.

In a seventh aspect, a provider revenue-cycle-management (“RCM”) embodiment receives claim parameters as an X12-837 claim draft or an HL7 FHIR Claim resource via a webhook and returns the final score, denial probability, and ordered checklist to an RCM workflow as a pre-submission step.

In an eighth aspect, a PARDD integration embodiment invokes, via a FHIR-based prior-authorization transaction stack, coverage-requirements discovery via a CDS-Hooks invocation, documentation templates and rules via a SMART-on-FHIR questionnaire driven by Clinical Quality Language logic, and prior-authorization support via a FHIR Claim bundle, updating the denial probability in real time based on responses received via the transaction stack.

Throughout this disclosure: each described layer may execute on any computing device, and the assignment of a layer to a client device or to server infrastructure in a given embodiment is an architectural choice of that embodiment except where a claim expressly recites the boundary; the term “large language model” means any generative sequence model capable of accepting the described prompt and honoring the described output constraints, regardless of vendor, hosting arrangement, parameter count, or architecture; and the identities of any cloud provider, model provider, or payer named herein are non-limiting examples only.

This Summary introduces selected concepts in simplified form and neither identifies essential features of the claimed subject matter nor limits the scope of the claims.

### BRIEF DESCRIPTION OF THE DRAWINGS

FIG. 1 is a high-level system architecture of the platform (100) showing its three scoring layers, large-language-model analysis layer, dual operating modes, and supporting cloud infrastructure.

FIG. 2 is a functional block diagram of the three-layer scoring stack plus the large-language-model analysis layer, comprising Layer 1 denial scoring engine (110), Layer 2 payer modifier (120), Layer 3 deterministic analysis (130), and the large-language-model analysis layer (140).

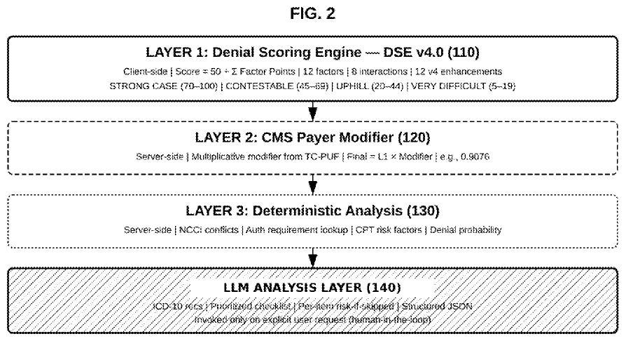

FIG. 3 is a data-flow diagram of the Layer 2 payer-transparency-data ingestion pipeline, depicting ingestion of Transparency-in-Coverage Public Use File (“TC-PUF”), Quality Rating System (“QRS”), and Individual Market Medical datasets into a scoring lookup table.

FIG. 4 is a functional diagram of the large-language-model analysis layer (140) showing grounded prompt construction, structured JSON output, and diagnosis-code recommendation generation.

FIG. 5 is a flowchart of the Layer 3 deterministic analysis (130) showing NCCI conflict detection, authorization requirement lookup, and denial probability computation.

FIG. 6 is a sequence diagram of the PARDD FHIR integration (150) showing CRD, DTR, and PAS transactions (anticipated to become operational as payer endpoints become available).

FIG. 7 is a data-flow diagram of the consumer EOB ingestion and extraction pipeline (200).

FIG. 8 is a breakdown of the Layer 1 denial-scoring-engine formula, including its additive baseline-neutral model, twelve intrinsic factors, and four scoring bands.

FIG. 9 is a flowchart of the pre-submission remediation checklist generation, showing the large-language-model analysis layer producing prioritized items with risk-if-skipped assessments.

FIG. 10 is a pipeline diagram of the appeal letter generation module (500).

FIG. 11 is an architectural diagram of the outcome feedback loop (600).

FIG. 12 is a user-interface wireframe of the “Predict and Prevent” tab (Mode A).

FIG. 13 is a user-interface wireframe of the “Dispute a Denial” tab (Mode B).

FIG. 14 is an infrastructure diagram showing an API gateway, compute functions (940), an identity service (910), an object store (920), a database service (930), and a secrets-management service within the supporting cloud infrastructure (900).

FIG. 15 is an end-to-end sequence diagram of the pre-submission scoring pipeline.

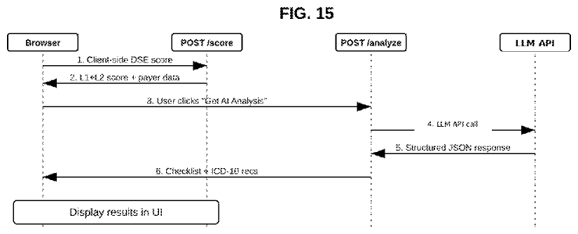

FIG. 16 is a block diagram of the pharmacy-benefit module (700).

FIG. 17 is a block diagram of the provider RCM module (800).

FIG. 18 depicts representative factor point tables and the band structure of the Layer 1 scoring engine, including illustrative point values for factors F1-F12 and the mapping of clipped scores to bands.

FIG. 19 depicts the EOB extraction canonical field schema and the per-field confidence and cross-validation flow of the consumer pipeline, including null-on-uncertain semantics and user-confirmation flagging.

FIG. 20 depicts the appeal-letter template structure, showing legal-skeleton portions designated immutable and the narrative fields designated for large-language-model personalization.

FIG. 21 depicts the bounded-adjustment authority model between the deterministic layers and the large-language-model layer, including the server-side clamp applied to any model-proposed score adjustment.

### DETAILED DESCRIPTION

### 1. Introduction and Definitions

In the following description, numerous specific details are set forth to provide a thorough understanding of one or more embodiments. It will be apparent, however, that the disclosed subject matter may be practiced without one or more of these specific details. Reference numerals are preserved across embodiments and drawings. Use of “comprising,” “including,” and “having” is intended as open-ended. Every numeric value, point table, weight, threshold, code list, and percentage appearing in this Detailed Description is illustrative of one embodiment unless a claim expressly recites it; alternative values, tables, and thresholds are within the scope of the disclosure.

The phrases “in some embodiments,” “in one embodiment,” and “in one illustrative embodiment” signal optional features. No described feature is essential unless recited in an independent claim. Features described with respect to one embodiment may be combined with features of any other embodiment except where physically or logically incompatible.

The following defined terms are used throughout the specification and the claims. Where a definition below differs from a customary usage, the definition below controls.

“Baseline-neutral” describes a property of an additive scoring model in which (a) the score begins at a predetermined baseline value representing a neutral prior, and (b) each factor whose input value is unknown, missing, or unparseable contributes exactly zero to the additive sum, so that the absence of information about a factor leaves the score at the baseline position with respect to that factor rather than penalizing or crediting the claim. Baseline-neutrality is what renders the structural score computable from any single available input: a claim described by only one known attribute receives the baseline value plus the single known factor's contribution, and no imputation, default penalty, or model-based estimate is substituted for the unknown factors.

“Factor contribution” means the signed point value contributed to the additive sum by a single intrinsic factor, determined by binning the factor's input value against that factor's point table and, in embodiments implementing confidence weighting, scaling the binned point value by a confidence value associated with the input. A per-factor decomposition enumerates each factor contribution separately so that the arithmetic provenance of the score is auditable.

“Structural score” means the output of the Layer 1 denial scoring engine: the baseline value, plus the sum of the factor contributions of the intrinsic factors, plus the sum of any interaction-rule deltas, the result clipped to a bounded range. The structural score reflects the intrinsic posture of the claim independent of the identity-specific behavior of the payer, which is applied separately as the payer modifier.

“Payer modifier” means an issuer-specific numeric value, derived from publicly published issuer-level payer-transparency data (including at least an issuer-level plan denial rate and an issuer-level appeal overturn rate), that is applied as a multiplicative adjustment to the structural score. In one worked example herein the payer modifier is the floating-point multiplier 0.9076. The payer modifier is maintained in a server-side scoring lookup table and is reported to the user interface as a field separate from the structural score.

“Risk-if-skipped assessment” means a natural-language field, generated for each item of an ordered remediation checklist, describing the specific adverse consequence expected if the user omits that item—for example, an automatic denial under a payer's prior-authorization rule, an NCCI edit rejection, or a downstream appeal-deadline forfeiture. The risk-if-skipped assessment is a per-item output field of the structured response contract, distinct from the item's priority level and from its recommended action.

“Legal-skeleton portion” means a region of an appeal-letter template that is designated immutable, such that the machine-generation pipeline is structurally prevented from modifying it during personalization. Legal-skeleton portions include regulatory citations, statutory notice language, state-insurance-regulator notices, and independent-review-organization references. Personalization by a large language model is confined to designated narrative fields; the legal-skeleton portions of the assembled letter are byte-identical to the template.

“Timeout budget” means the maximum wall-clock time that an intermediary gateway, orchestration service, or calling context allots to a request before terminating it. Where an output-length constraint is described as being determined “as a function of the timeout budget,” the maximum output size (for example, the maximum number of checklist items) is chosen such that the expected generation time of the constrained output, plus prompt-processing and network overhead, completes within the timeout budget.

“Client device” means any computing device operated by an end user at which the user interface is presented and at which client-side computation executes, including without limitation a workstation, laptop, tablet, smartphone, or terminal executing a web browser or a native application.

“Compute function” means a unit of server-side executable logic, however hosted, including a serverless function-as-a-service function, a container, a virtual-machine process, or an on-premises service. Example compute-function runtimes referenced herein include JavaScript runtimes (e.g., Node.js 18.x) and Python runtimes (e.g., Python 3.12); the runtime identity is non-limiting.

“Object store” means a storage service addressing immutable or versioned objects by key, with optional lifecycle policies and object-level encryption; “database service” means a keyed record store supporting conditional writes and secondary indexes. Both may be cloud-hosted or on-premises.

“Issuer” means the legal entity offering a health plan, resolvable at plan level, issuer-state level, or issuer-national (group) level; “line of business” (“LOB”) means the regulatory market segment of the coverage—for example, commercial ACA-individual, employer-group ERISA, Medicare Advantage, Medicaid managed care, traditional Medicare fee-for-service, or CHIP—which determines both scoring table rows and the applicable appeal regulatory regime.

“Payer-transparency data” means publicly published, machine-readable, issuer-level data reporting claim-adjudication behavior, and expressly includes: CMS Transparency-in-Coverage Public Use Files (TC-PUF); CMS Quality Rating System (QRS) data; CMS Individual Market Medical data; prior-authorization metrics published pursuant to CMS-0057-F; and any equivalent public issuer-level dataset published by a federal or state regulator or pursuant to a transparency mandate. Payer-transparency data is distinguished from a proprietary claims corpus in that it is published, versioned, uniformly available to all parties, and compiled by the platform into a bounded-size lookup table rather than used to train a statistical model.

“Large language model” (“LLM”) means any generative sequence model—whatever its vendor, architecture, hosting arrangement (commercial API, cloud-hosted managed model service, or self-hosted weights), or modality—capable of accepting a structured prompt and honoring the output constraints described herein, including a structured machine-readable output format, a grounding directive, and a length constraint. A “vision-enabled” model additionally accepts document images as input. References herein to any specific commercial LLM API are illustrative only.

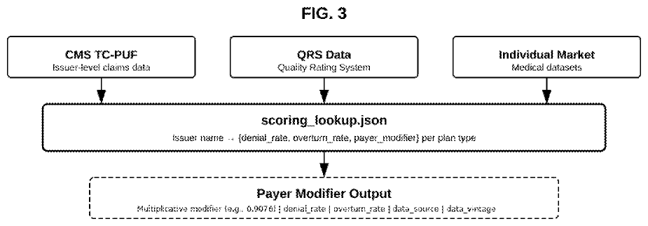

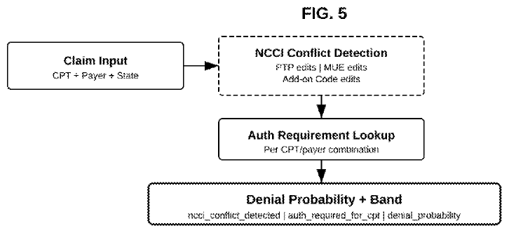

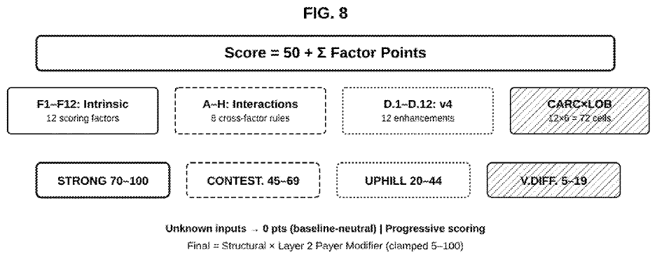

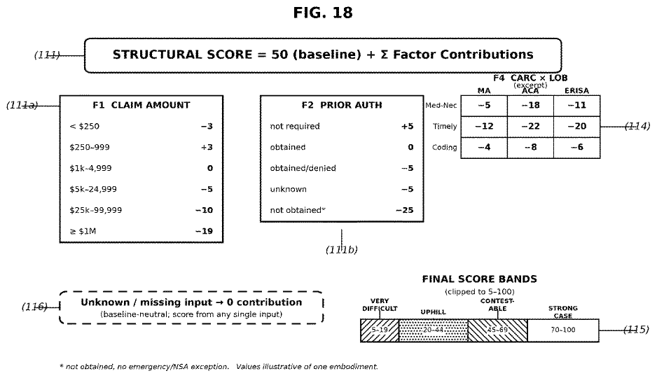

As used herein, “engine,” “module,” “layer,” and “function” each denote one or more hardware processors configured by stored instructions to perform the algorithms described for that component—for the denial scoring engine, the algorithms of paragraphs [0066]-[0099] and FIGS. 8 and 18; for the deterministic analysis engine, the algorithms described with reference to FIG. 5; for the payer-modifier stage, the derivations of paragraphs [0101]-[0104] and FIG. 3 —and are not intended to invoke 35 U.S.C. 112(f).

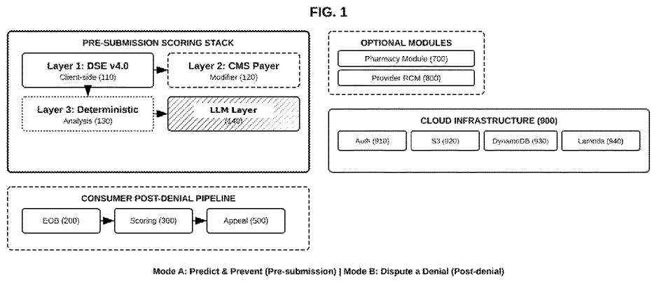

### 2. System Architecture and Dual Operating Modes (FIGS. 1, 12, 13, 14)

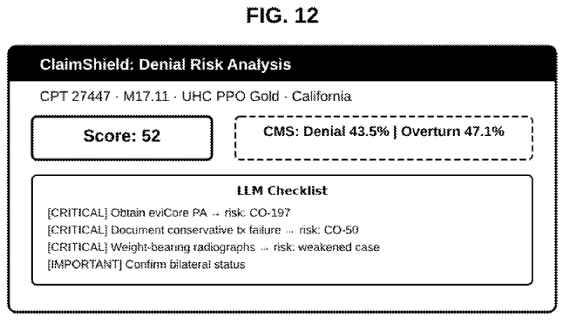

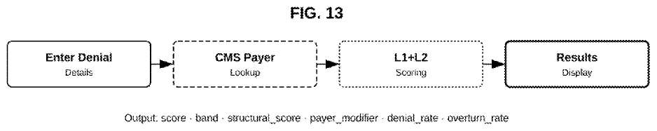

Referring to FIG. 1, the platform (100) operates in two modes sharing a common scoring engine. Mode A (“Predict and Prevent,” FIG. 12) accepts pre-submission claim parameters from a clinician and produces a denial risk score with an ordered remediation checklist. Mode B (“Dispute a Denial,” FIG. 13) accepts post-denial parameters including a CARC code and produces an appeal viability score with payer denial and overturn rates sourced from payer-transparency data. Because both modes execute the same Layer 1 engine and consult the same Layer 2 lookup table, improvements to either data path (for example, a refreshed lookup table) benefit both modes without duplicated logic.

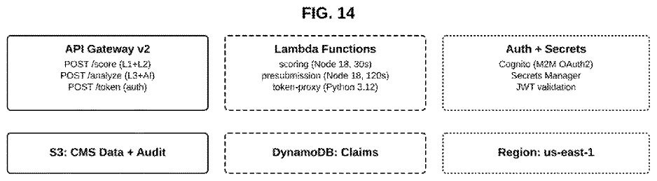

Referring to FIG. 14, supporting cloud infrastructure (900) in one embodiment comprises: an API gateway providing REST endpoints (e.g., POST/score for Layer 1+Layer 2 scoring; POST/analyze for Layer 3 plus the LLM analysis layer; POST/token for the authentication proxy; and, in some embodiments, POST/claims/save, GET/claims/history, and an asynchronous POST/score/async variant orchestrated by an express workflow service); an identity service (910) providing machine-to-machine OAuth2 client-credentials authentication with JSON Web Token (“JWT”) validation at the gateway (in some embodiments extended with authorization-code-with-PKCE flows, machine-to-machine scopes, and SMART-on-FHIR session authentication); compute functions (940) implementing the server-side layers; a secrets-management service storing the LLM API credential; an object store (920) holding payer-transparency reference data and the scoring lookup table; and a database service (930) holding claim records, versioned weight records, and audit logs. In one illustrative deployment the compute functions include a scoring function (approximately 512 MB memory, 30-second timeout), a pre-submission analysis function (approximately 1024 MB memory, 120-second timeout), and a token-proxy function (10-second timeout), deployed in a single cloud region; each of the runtime language, memory size, timeout, and region is a non-limiting deployment parameter, and JavaScript (e.g., Node.js 18.x) and Python (e.g., Python 3.12) runtimes are both illustrative.

The identity service (910) is described generically: any service issuing verifiable bearer tokens under an OAuth2 client-credentials grant (as one example) may serve, and JWT validation may occur at the gateway, within each compute function, or both.

In one embodiment a token-proxy compute function resolves a browser cross-origin resource sharing (“CORS”) restriction as follows: a web-browser client cannot directly call the identity service's token endpoint because that endpoint does not emit the CORS response headers the browser's same-origin policy requires; the token-proxy function therefore accepts the browser's token request at a gateway endpoint under the platform's own origin policy, performs the OAuth2 client-credentials exchange server-side, and returns the issued token to the browser with the appropriate cross-origin response headers. This mechanism permits a purely static, client-side application to obtain gateway credentials without embedding secrets in browser code and without relaxing the identity service's origin policy.

A defining architectural boundary of the platform is client-local structural scoring with explicit-invocation server escalation. The Layer 1 engine executes entirely at the client device: no claim parameter is transmitted to any server for the structural score to be computed, recomputed, or interactively explored. The Layer 2 payer modifier, the Layer 3 deterministic analysis, and the LLM analysis layer are invoked only upon an explicit user action taken after the structural score is displayed. This boundary (i) eliminates network round trips from the interactive scoring loop, so that every input change rescores at local-computation latency; (ii) confines claim parameters to the client device during exploratory scoring, minimizing data exposure; and (iii) reduces server load to explicitly requested analyses. The inventors are not aware of any well-understood, routine, or conventional arrangement in claim-scoring systems that places a complete multi-factor structural scoring engine at the client device with server layers gated behind explicit invocation; the arrangement is a deliberate, non-generic allocation of computation chosen for its data-locality and latency properties. Client-local scoring with zero transmission of claim-identifying parameters thereby reduces network round-trips, scoring latency, and the protected-data exposure surface relative to server-scoring architectures, directly addressing the technical problem described in paragraph [0008]. At scoring time, the structural score and the payer modifier are computed entirely by deterministic table lookup and additive or multiplicative arithmetic: no learned embedding of the claim-identifying parameters is generated, and no neural network or other machine-learning model trained on historical claim-outcome labels is applied at scoring time. The outcome-feedback retraining described elsewhere herein operates offline on versioned coefficient tables under the population calibration gate and human-in-the-loop review, and does not alter the deterministic character of scoring-time computation. The categorical warning produced by the deterministic edit analysis is likewise generated independently of the denial probability and of any output of the large language model. As used herein, a categorical warning is a warning value selected from an enumerated set of warning categories and carried in a data field separate from the field carrying the denial probability.

### 3. Layer 1—Denial Scoring Engine (110) (FIGS. 8, 18)

Layer 1 (110) is a client-side, stateless, inference-only structural scoring engine (denial scoring engine version 4.0, “DSE v 4.0”) implementing the additive baseline-neutral formula: Score=50+sum(Factor Points). The baseline of 50 represents a neutral starting point. The score is modified by twelve intrinsic factors (F1-F12): F1 claim dollar amount; F2 prior authorization status (obtained, obtained-and-denied, not-obtained, not-required, unknown); F3 network status (in-network, out-of-network, out-of-network at an in-network facility for No Surprises Act (“NSA”) eligibility); F4 a CARC-by-line-of-business matrix (12 CARC groups×6 line-of-business types=a 72-cell lookup table); F5 line of business (e.g., HMO, PPO, EPO, POS, HDHP plan types within the market segment); F6 metal tier (Bronze, Silver, Gold, Platinum, Catastrophic); F7 service category; F8 place of service (CMS POS codes); F9 state regulatory tier (a 51-jurisdiction table); F10 provider specialty; F11 modifier usage; F12 prior appeal history.

Eight interaction rules (A-H) provide cross-factor adjustments. Twelve v4 enhancements (D.1-D.12) add: D.1 confidence-weighted deductions; D.2 missing-data bin handling (unknown inputs score 0, baseline-neutral); D.3 cross-factor consistency validation; D.4 a prior-appeal-history factor; D.5 an NSA-plus-state interaction; D.6 multi-CARC handling; D.7 a catastrophic-claim log tail; D.8 plan-subtype expansion; D.9 an explanation JSON contract; D.10 an evidence-freshness flag; D.11 score-band stability; and D.12 a population calibration gate. Progressive scoring fires on any single available input. Bands: STRONG CASE 70-100; CONTESTABLE 45-69; UPHILL 20-44; VERY DIFFICULT 5-19. A display floor of 5 applies.

Stated formally, in one illustrative embodiment: Score_raw=50 +(the sum over factors i of Points_i(bin(x_i)))+(the sum over triggered interactions j of InteractionDelta_j), where bin(x_i) maps the i-th factor's input value to a bin of that factor's point table and Points_i returns the bin's signed point value; and Score_display=clip(Score_raw, 5, 100). The clip bounds serve two technical functions: they guarantee a stable display range for band assignment regardless of extreme factor combinations, and they prevent any single pathological input from driving the score outside the calibrated region of the band edges.

In some embodiments a logistic preparation layer converts the additive score to a calibrated probability: a scaling factor Factor=20/ln(2)≈28.854 (a “points-to-double-odds” of 20) defines a linear predictor LP=(Score_raw−50)/Factor, and an overturn probability is computed as P(overturn)=σ(α_LOB+γ_LOB·LP′), where α_LOB is a per-line-of-business intercept anchor, γ_LOB is a per-line-of-business slope held at 1.0 until at least a threshold number of observed outcomes (e.g., N≥200) supports estimation, and σ is the logistic function. This preparation layer permits the same additive scorecard to emit either a banded score or a calibrated probability without retraining.

The baseline-neutral missing-data semantics are a specific technical solution to the sparse-input problem identified in paragraph [0007]. Because an unknown input contributes zero points, the engine is progressively operable: it produces a meaningful, decomposable score from a single known input, and each additional known input moves the score monotonically according to that input's point table, never through imputation. In one illustrative embodiment a progressive gate requires at least one of {state, payer group, line of business} to be present before scoring fires; in the principal embodiment any single available input suffices. In embodiments with uncertainty quantification, unknown inputs additionally widen the confidence interval (for example, multiplying the per-factor uncertainty standard deviation by a factor between 1.2 and 2.0) so that thin-input scores are visibly less certain rather than silently penalized.

Paragraphs [0072] through [0083] set out representative point tables for the twelve intrinsic factors, depicted in FIG. 18. All point values are illustrative of one embodiment (“in one illustrative embodiment”) and may be recalibrated, re-binned, or replaced without departing from the disclosure.

F1—Claim dollar amount. The billed amount is mapped through logarithmically spaced bins carrying increasingly negative contributions as the amount grows, from approximately −3 points for the lowest non-trivial bin to a cap of approximately −19 points at the catastrophic tail (see D.7). Logarithmic binning reflects that denial exposure scales with the order of magnitude of the claim rather than linearly with dollars.

F2—Prior authorization status. Illustrative contributions: not_required +5; obtained +4; obtained-and-denied −8; unknown 0; not_obtained_with_exception −12; not_obtained_no_exception −25. The −25 bin is the largest single negative contribution in the engine, reflecting near-automatic denial where authorization was required and not obtained.

F3—Network status. Illustrative contributions: in-network +5; out-of-network at an in-network facility with NSA eligibility indicia, approximately neutral to positive pending Rule B; out-of-network without NSA protection −20.

F4—CARC×line-of-business matrix. Twelve CARC families (for example: medical necessity; timely filing; prior authorization; bundling/NCCI; non-covered service; coordination of benefits; duplicate; eligibility; documentation; coding specificity; out-of-network; experimental/investigational) are crossed with six line-of-business types to form a 72-cell table of signed contributions. Illustrative cells: the medical-necessity family ranges from −5 in Medicare Advantage to −18 in ACA-individual coverage; the timely-filing family ranges from −20 to −25 across lines of business, reflecting that timely-filing denials are procedurally difficult to reverse in every market. The matrix encodes the empirical reality that the same CARC family carries different appeal postures under different regulatory regimes.

F5—Line of business. Illustrative contributions range from +8 for traditional Medicare fee-for-service to −12 for Medicaid managed care, with commercial plan types intermediate.

F6—Metal tier. Illustrative contributions range from +2 to −3 across Platinum, Gold, Silver, Bronze, and Catastrophic tiers.

F7—Service category. Illustrative contributions range from +5 for evaluation-and-management services to −18 for post-acute care.

F8—Place of service. Illustrative contributions keyed to CMS POS codes range from +3 for POS 11 (office) to −10 for POS 31/32 (skilled-nursing settings).

F9—State regulatory tier. The 51 U.S. jurisdictions are grouped into five tiers by external-review strength and regulator posture. Illustrative contributions: Tier 1 +3 (e.g., California, New York, Washington, Connecticut, Pennsylvania, Maryland, New Jersey, Massachusetts, Illinois, Colorado) descending to Tier 5 −8 (e.g., Texas, Wyoming).

F10—Provider specialty. Illustrative contributions range from +3 to −7 across specialty groups, reflecting specialty-linked utilization-review intensity.

F11—Modifier usage. Fourteen illustrative modifier patterns carry contributions from +2 (no modifier where none is expected) to −6 (modifier 59), with a distinct −10 contribution for an NCCI-editable code pair submitted with no distinguishing modifier at all.

F12—Prior appeal history. Illustrative contributions range from +2 (no prior appeal) to −12 (an independent-review-organization upholding of the denial). In embodiments with the logistic preparation layer of paragraph [0069], each previously failed appeal stage additionally shifts the intercept by approximately −0.35 (see D.4).

Interaction rules. Eight cross-factor interaction rules A-H apply signed deltas when specified factor-value combinations co-occur, capturing risk that is conditional rather than marginal. Each rule is defined by a predicate over two or more factor values and a fixed delta; the rules are evaluated after the factor contributions and their deltas enter the additive sum of paragraph [0068].

In one illustrative embodiment: Rule A applies −6 when the service category is post-acute care and the line of business is Medicare Advantage. Rule B applies +6 when the network status indicates an out-of-network ancillary or emergency provider at an in-network facility eligible for federal surprise-billing protection under the NSA. A surprise-billing adjustment under Rule B (and the corresponding Mode B adjustment) is applied when the claim bears indicia of emergency services or of an out-of-network provider at an in-network facility and the date of service is after Jan. 1, 2022, the effective date of the federal surprise-billing protections; claims with earlier dates of service are evaluated without the adjustment. Rule C applies −5 when the claim is a behavioral-health or substance-use-disorder claim in a state where federal parity requirements are directly enforced by CMS rather than by the state. Rule D applies −4 upon detection of an emergency-department downcoding pattern; because this predicate requires payer-behavior data, Rule D is evaluated at the server-side stage in this embodiment.

Rules E1-E5 apply plan-subtype deltas: dual-eligible special-needs plan (“D-SNP”) −3; chronic-condition special-needs plan (“C-SNP”) −2; institutional special-needs plan (“I-SNP”) −4; Medicare-Medicaid plan (“MMP”) −3; Program of All-Inclusive Care for the Elderly (“PACE”) −2.

Rule F applies −4 when the claim's utilization management is routed through a third-party utilization-management vendor and the payer's Layer 2 adjustment is worse than −0.35, capturing the compounding of vendor-routed review with an already-adverse payer. Rule G applies a graduated timely-filing delta of −2, −5, or −8 as the filing window consumed increases. Rule H applies +3 in any of ten “NSA-plus” states whose state law extends surprise-billing protection beyond the federal floor, and fires only in combination with Rule B (see D.5).

In an alternative embodiment (an engine generation designated v6), three further interaction rules are defined: Rule I applies −8 upon a medically-unlikely-edit violation; Rule J applies −10 upon a national-or local-coverage-determination conflict; and Rule K applies −6 upon an NCCI procedure-to-procedure conflict; and a 0.5× attenuation multiplier is applied to Medicare-derived edit rules when the line of business is not Medicare, reflecting that non-Medicare payers adopt Medicare edits only partially.

Enhancement D.1—Confidence-weighted contributions. Each factor contribution is scaled by a confidence value: Contribution_i=Points_i(bin(x_i))×max(c_i, floor(tier_i)), where c_i∈[0, 1] is the confidence attached to the i-th input (for example, a per-field extraction confidence from the EOB pipeline of Section 7) and floor(tier_i) is a tier-specific minimum (illustratively 0.40, 0.30, or 0.25 by evidence tier), preventing a low-confidence input from being either fully trusted or entirely discarded.

Enhancement D.2—Missing-data bins. Every factor's point table contains an explicit “unknown” bin scoring exactly 0, implementing the baseline-neutral definition of paragraph ; in uncertainty-quantifying embodiments the unknown bin also widens the confidence interval per paragraph [0070]. Enhancement D.3—Cross-factor consistency validation. Before scoring, the engine validates that jointly impossible input combinations (for example, a metal tier asserted on a Medicare fee-for-service claim) are rejected or down-weighted, and implements the progressive gate.

Enhancement D.4—Prior-appeal-history factor. F12 is applied as a scored factor and, in logistic embodiments, as the per-failed-stage intercept shift of paragraph [0083]. Enhancement D.5—NSA-plus-state interaction. Rule H's state list and its conjunction requirement with Rule B are maintained as a versioned data table rather than code, so state-law changes are data updates.

Enhancement D.6—Multi-CARC handling. When a claim bears multiple CARC codes, the F4 lookup selects the worst-scoring cell as the primary contribution while preserving the remaining codes as secondary contributions in the explanation output. Enhancement D.7—Catastrophic-claim log tail. The F1 logarithmic binning is capped at −19 points so that arbitrarily large billed amounts asymptote rather than dominating the additive sum.

Enhancement D.8—Plan-subtype expansion. The plan-subtype vocabulary of Rules E1-E5is extensible by data update. Enhancement D.9—Explanation JSON contract. The engine emits a machine-readable explanation document (schema identifier “claimshield.explanation.v4.0” in one embodiment) enumerating each factor contribution, each triggered interaction rule and its delta, the raw and clipped scores, the band, and any flags—making the entire computation reproducible and auditable from the output alone.

Enhancement D.10—Evidence-freshness flag. Each scoring weight carries a provenance date; when the highest-tier (“Tier A”) evidence supporting a weight is older than a staleness threshold (illustratively 540 days), the output is flagged stale. Enhancement D.11—Score-band stability. When the uncertainty interval is wide (illustratively, when the 95th-percentile score minus the 5th-percentile score exceeds 20 points), the user interface displays a wide-confidence-interval badge rather than presenting a falsely precise single band.

Enhancement D.12—Population calibration gate. Before any scoring-weight set is deployed, it is scored against a synthetic claim population (illustratively 10,000 synthetic claims) and must pass a battery of calibration checks (illustratively nine), including: the population mean score falling within 50±4; thin-input claims scoring within [45, 55] at the 95% level; and no single factor accounting for more than 40% of total signed points. A weight set failing any check is blocked from deployment. The gate is a deployment-control mechanism, not a training step: it validates a candidate lookup table against invariants rather than fitting parameters to outcomes.

Uncertainty quantification. In one embodiment, per-factor point values are treated as truncated-normal random variables; a Monte Carlo procedure using Latin hypercube sampling with Iman-Conover correlation induction and N=5,000 draws produces a score distribution from which the 5th and 95th percentiles are reported alongside the point score. In an alternative embodiment an analytic-normal approximation propagates per-factor variances in closed form, trading distributional fidelity for constant-time computation on low-power client devices. In a further alternative, no uncertainty is computed and only the point score is displayed.

Alternative parameterizations. In some embodiments the additive model is expressed in an algebraically equivalent baseline-credit form, in which each factor's table is shifted so that its best bin scores zero and the baseline value absorbs the aggregate shift; the two forms produce identical clipped scores and differ only in table presentation. In some embodiments the clip bounds are [15, 100] rather than [5, 100], with band edges at 80/60/40; in another deployed embodiment the band edges are 80/50 over a clamp of [0, 100] with final score computed as clamp(0, 100, structural score×payer modifier). The bounded range, the baseline value, and the band edges are configurable parameters of the engine, and the specific values 5, 50, 100, 70, 45,and 20 recited for the principal embodiment are one calibration.

In one deployed dispute-mode embodiment, a timing-decay multiplier is additionally applied: a claim whose appeal deadline has expired scores 0; a claim with less than 10% of its appeal window remaining is multiplied by 0.70; less than 25% remaining, by 0.85. That embodiment also emits categorical flags (e.g., EMERGENCY_OON_NSA when federal surprise-billing indicia are present; MHPAEA_PARITY when behavioral-health parity indicia are present) and a recoverable-estimate percentage field.

Alternative unknown-input semantics. In an alternative embodiment (the v6 generation), selected factors assign a small negative point value to the unknown bin rather than zero, encoding a prior that missing documentation is itself weak evidence of an incomplete claim. The baseline-neutral zero-scoring semantics of paragraph [0047] remain the principal embodiment; the negative-unknown variant is expressly disclosed as an alternative and is not baseline-neutral within the meaning of the defined term.

### 4. Layer 2—Payer Modifier (120) (FIG. 3)

Layer 2 (120) is a server-side multiplicative modifier derived from real payer-transparency data. In the principal embodiment three CMS datasets are compiled into a scoring lookup table: TC-PUF issuer-level claims data, QRS data, and Individual Market Medical data. For a given claim, Layer 2 resolves the payer by issuer name and plan type, retrieves the issuer-specific denial rate and overturn rate, and computes a payer modifier (a floating-point multiplier, e.g., 0.9076). Final Score=clip(Structural Score×Payer Modifier, 5, 100). Because the modifier is multiplicative, its effect scales with the structural score—an adverse payer depresses a strong claim more points than a weak one—while the additive Layer 1 decomposition remains intact and separately reportable.

Three alternative mathematical derivations of the payer modifier are disclosed; each consumes the same compiled lookup table and each is within the meaning of “payer modifier” as defined in paragraph [0050].

Derivation 1—direct multiplicative table. The lookup table stores, per canonical issuer group and line of business, a directly assigned multiplier. In one illustrative deployed table: Issuer Group 1, 1.35; Issuer Group 2, 1.20; Issuer Group 3, 1.18; Issuer Group 4, 1.15; Issuer Group 5, 1.12; Issuer Group 6, 1.05; Medicaid managed care, 0.95; an integrated staff-model issuer group, 0.90; traditional Medicare, 0.80. The multiplier values are compiled from the transparency data at table-build time, so the runtime operation is a single keyed lookup.

Derivation 2—ratio to baseline. The modifier is derived as a function of the ratio of the issuer-specific denial rate to a baseline denial rate computed from the same payer-transparency data (for example, the line-of-business mean), so that an issuer denying at the baseline rate receives a modifier of approximately 1.0 and issuers denying above or below baseline receive proportionally adjusted modifiers. The worked example of Section 11 (payer modifier 0.9076 from a 43.5% denial rate and 47.1% overturn rate) illustrates this family.

Derivation 3—capped log-odds adjustment. An adjustment Δ=logit(issuer denial rate)−logit(line-of-business mean denial rate) is computed, sign-conditioned so that above-mean denial behavior lowers the appeal-favorability signal, and capped to ±0.50 to prevent any single issuer's extreme published rate from dominating. The capped adjustment is consumed either (a) through the logistic recalibration layer of paragraph [0069], entering the linear predictor alongside the points-to-double-odds scaling of pdo=20, or (b) converted to a multiplicative form as exp(clamp(Δ, −0.50, +0.50)); a linear approximation 1.0+2Δ is a further alternative. In illustrative published compilations, issuer-group adjustments in a 2024 Medicare Advantage dataset ranged from −0.50 (for the issuer group with an observed denial rate of approximately 12.8%, the most adverse in that dataset) to +0.12, and in a 2024 individual-market dataset from −0.50 to +0.55.

Lookup table schema. In one embodiment the compiled scoring lookup table is a single versioned document (illustratively approximately 1 MB) with top-level sections {plans, issuers, issuer_national, state_benchmarks, national_benchmarks}, supporting resolution at descending specificity. The compilation formulas are: denial_rate=total_denied/total_claims, and overturn_rate=(internal_overturned+external_overturned)/(internal_appeals+external_appeals), each computed per issuer (and, where the source data supports it, per plan and per state) from the TC-PUF fields.

Hierarchical fallback. When the requested key is absent at the most specific level, resolution falls back through a fixed hierarchy—in one deployed embodiment payer×state×procedure code → issuer-state → issuer-national → state benchmark → national benchmark, and in the specification-level embodiment a four-tier variant with plan-type defaults—terminating at national default rates (illustratively a 0.26 denial rate and a 0.42 overturn rate). The resolution level actually used is reported in the output so the user interface can indicate specificity.

Issuer-name normalization. Because transparency filings name issuers inconsistently across states and years, brand-level issuer names are normalized to canonical issuer groups keyed by National Association of Insurance Commissioners group codes (illustratively group codes 707, 1295, 1, 671, 901, 119, and 1288 for seven large national groups), with alias rules mapping subsidiary and doing-business-as names onto their group. A vendor double-count rule prevents claims administered by a utilization-management vendor on behalf of an issuer from being attributed to both entities.

Refresh and provenance. The scoring lookup table is recompiled on a periodic schedule—quarterly in the principal embodiment—from updated releases of the payer-transparency data (illustrative vintages: TC-PUFs for 2017-2026; QRS plan years 2020-2026; CMS-0057-F prior-authorization and overturn metrics as of Mar. 31, 2026). Each compiled table carries a weight-version identifier (e.g., “01HZV6_LAUNCH_2026Q2”), and each scoring response reports a data-source identifier (e.g., “cms_tic_puf”) and the dataset vintage from which the modifier was derived, so every score is traceable to a specific public data release. In one embodiment, provenance is additionally maintained at entry granularity: each entry of the compiled scoring lookup table stores a data-source identifier and a data-vintage identifier of the specific payer-transparency release from which that entry was compiled, so that entries compiled from different releases coexist within a single compiled table without loss of traceability, and so that the data-source and data-vintage identifiers reported with each scoring response are read from the entry actually used. In some embodiments, retrieval of a payer modifier is conditioned on the data-vintage identifier of the entry satisfying a configurable recency threshold; when no entry for the identified issuer satisfies the recency threshold, resolution proceeds through the hierarchical fallback of paragraph [0106] to a benchmark modifier and the response is flagged accordingly. Conditioning modifier selection on entry-level data vintage prevents a stale published rate from silently driving a current score, extending the evidence-freshness safeguard of paragraph [0094] from scoring weights to payer-transparency entries.

Hot reload. In some embodiments, compute functions cache the lookup table and other reference objects in memory and revalidate them against the object store by entity-tag (ETag) comparison on a time-to-live schedule (illustratively 300 seconds), so a recompiled table takes effect across the fleet without redeploying any function.

The Layer 2 design is a data-architecture solution to the cold-start problem of paragraph [0007]: payer-specific behavior enters the score through a bounded-size, versioned, publicly reproducible lookup table compiled from published data, rather than through a trained model requiring a proprietary claims corpus, a training pipeline, and drift monitoring. The platform is fully operational on the day the first public data release is compiled, with zero historical claims observed. The inventors are not aware of any well-understood, routine, or conventional claim-scoring arrangement in which the payer-specific signal is compiled from published regulatory transparency data into a versioned multiplicative lookup applied over a client-computed additive scorecard.

### 5. Layer 3—Deterministic Analysis (130) (FIG. 5)

Layer 3 (130) performs: (i) denial probability computation based on procedure-code-specific risk factors and payer behavior patterns; (ii) NCCI edit conflict detection (Procedure-to-Procedure (“PTP”), Medically Unlikely Edit (“MUE”), and Add-on Code edits); (iii) per-procedure-code per-payer authorization requirement lookup; and (iv) denial probability band assignment. Layer 3 executes server-side via a compute function with a 120-second timeout in one embodiment.

In one illustrative embodiment the denial probability is a weighted combination: denial_probability=payer_cpt_rate×0.35+auth_risk×0.30+icd10_risk×0.20+doc_risk×0.15, expressed on a 0-100 scale, adjusted by a per-payer term bounded to ±15, clamped to [0,100], and banded LOW (<20), MODERATE (<45), HIGH (<70), and CRITICAL (≥70). The weights 0.35/0.30/0.20/0.15, the ±15 adjustment bound, and the band edges are illustrative calibrations.

Diagnosis-code specificity sub-scorer. Each ICD-10 code is scored for specificity risk on [0, 1]: illustratively 0.05 for a fully specific seven-character code, rising through intermediate values for truncated or unspecified codes, to 1.00 for an invalid code; a watchlist of frequently denied unspecific codes (e.g., M17.9, M54.5) scores 0.85; and a bilateral-procedure code set triggers a laterality-required check pairing the procedure code against laterality-bearing diagnosis codes.

Authorization-risk sub-scorer. A curated set of high-authorization-scrutiny procedure codes (illustratively approximately twenty codes) is combined with a per-payer aggressiveness coefficient, and a lead-time penalty (illustratively +0.15) is added when the scheduled date of service is fewer than seven days away—too close for a standard authorization decision timeframe.

Documentation-completeness sub-scorer. Documentation risk is a weighted checklist over the clinician-supplied documentation state, with illustrative category weights: prior-authorization documentation 0.40; clinical documentation 0.30; coding documentation 0.15; site-of-care justification 0.10; timing documentation 0.05; evaluated over sixteen enumerated item identifiers in one embodiment.

NCCI PTP edits. The PTP table is keyed as “{lower code}_{higher code}” → modifier indicator, with the standard indicator semantics: 0, the pair is never separately payable and no modifier can rescue it; 1, the pair is payable with an appropriate distinguishing modifier; 9, the edit is not applicable. In one full-table embodiment the PTP table holds on the order of 800,000 pairs; a deployed embodiment carries a curated subset (illustratively 3,347 pairs) selected for the platform's covered procedure domains. A detected conflict is emitted as a categorical warning distinct from the denial probability, and in checklist-generating embodiments the first checklist item is required to address the detected conflict.

MUE and add-on edits. Each MUE record stores {value, MAI}, where MAI is the MUE Adjudication Indicator; the edit fires when the claimed units exceed the value and the MAI is 2 or 3 (per-date-of-service edits). Add-on-code edits verify that each claimed add-on code is accompanied by an acceptable primary procedure code.

Coverage-determination lookup. In some embodiments a procedure-code-to-coverage-determination map (e.g., mapping CPT 27447 to a local coverage determination identifier such as L36007) with covered-diagnosis prefixes per Medicare administrative contractor jurisdiction supports detection of national-or local-coverage conflicts (see Rule J of paragraph [0088]).

Per-payer rules structure. Authorization lookup consults a per-payer rules document with fields {um_vendor, portal_url, auth_validity_days, pa_lead_time_days, auto_deny_without_pa_pct, cpt_rules}. The auto-deny-percentage field records the observed share of unauthorized claims automatically denied by that payer's utilization-management arrangement (illustratively 94% for one large national payer routing through a third-party UM vendor, and 88% for another); the um_vendor field feeds interaction Rule F of paragraph [0087].

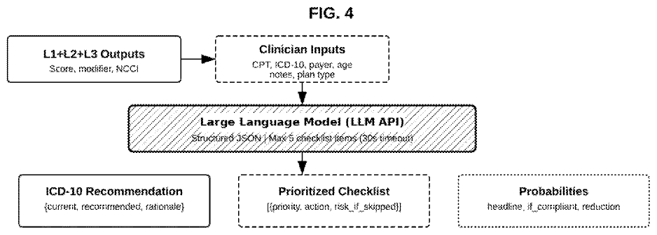

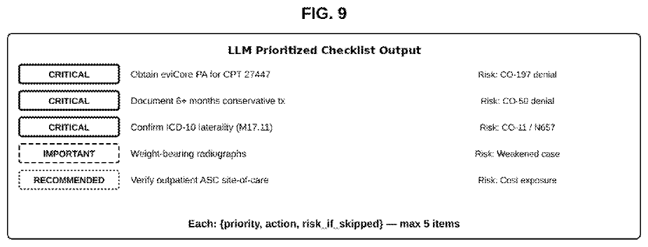

### 6. Large-Language-Model Analysis Layer (140) (FIGS. 4, 9, 21)

The LLM analysis layer (140) receives the Layer 1-3 outputs plus clinician-provided inputs (procedure code, ICD-10 code, payer, state, patient age, billed amount, plan type, and documentation notes) and generates structured JSON comprising: (a) a headline denial probability; (b) a projected probability if compliant; (c) a probability reduction; (d) an ICD-10 specificity recommendation {current_code, recommended_code, rationale}; and (e) a checklist—an ordered array where each item carries {priority, action, risk_if_skipped}. The prompt includes a conciseness constraint (a maximum of five items in the principal embodiment) to remain within a 30-second API-gateway timeout. The LLM layer is invoked only when the user explicitly requests it after reviewing the Layer 1+Layer 2 results.

Any generative sequence model satisfying paragraph [0059] may serve as the LLM; embodiments include a commercial LLM API called over the network with the credential held in the secrets-management service, and a cloud-hosted managed model service invoked within the provider's network boundary (in which case prompt caching of the static prompt prefix may be enabled). The model identity and hosting arrangement are non-limiting.

Full structured response schema. In one illustrative embodiment the response schema comprises: denial_probability_after_checklist (numeric); checklist —an ordered array of four to eight items (bounded per the timeout budget; at most five under a 30-second gateway), each item carrying {id; priority ∈{critical, important, recommended}; category (one of six defined categories); step_number; title; detail; risk_without; specific_to_payer (boolean); estimated_time_minutes}; icd10_recommendation {current_code, recommended_code, rationale}; modifier_flags; prior_auth {required, portal, lead_time_days}; a timing recommendation; a site-of-care recommendation; and score_v3_adjustment, a bounded numeric adjustment discussed in paragraph [0124]. The risk_without field is the risk-if-skipped assessment of paragraph [0051]; per-item output is additionally constrained to a TITLE/DETAIL/RISK_WITHOUT presentation format so the client renderer never parses free prose.

Grounding directives. The system prompt includes directives that confine generation to supplied facts, illustratively: “the deterministic scores provided are facts; do not re-estimate them”; “never invent a portal name, LCD number, or payer policy not present in the provided data”; and, for citation fields, “if no controlling citation is present in the provided data, set controlling_citation to null and DO NOT invent a regulation.” These directives operationalize a null-over-guess policy: every field that would otherwise invite fabrication has an explicit null semantics. Generation is performed at temperature 0 in the principal embodiment, and output is constrained to JSON only.

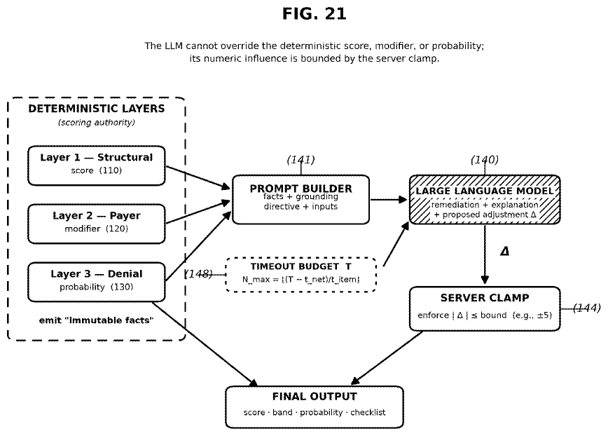

Bounded-adjustment authority model (FIG. 21). The deterministic layers hold scoring authority; the LLM holds explanatory and remediation authority plus a strictly bounded adjustment authority. The model may propose a score adjustment (score_v3_adjustment), and the server clamps any proposed adjustment to a bounded range—illustratively [−5, +5] points—before application, so the generative component cannot override the structural score, the payer modifier, or the deterministic denial probability regardless of what it emits. Relatedly, the prompt constrains the projected probability if compliant to be less than the headline denial probability, and the server rejects a response violating that ordering. This authority separation is a structural safeguard, enforced in server code rather than requested of the model. As used herein, the large language model is “structurally prevented” from overriding a deterministic value in the sense that the server-side clamp caps any model-proposed adjustment to the bounded adjustment range before any application of the adjustment, such that no output the model emits can change that value by more than the bounds of the range. The server-side clamp depicted in FIG. 21 is a technical gating mechanism that improves the reliability of the computing system's outputs by structurally preventing any generative-model output from overriding the deterministic scoring results, addressing the technical problem described in paragraph [0009].

Timeout-budget arithmetic. Let T be the gateway timeout (30 seconds in the principal embodiment), t_net the budgeted network and prompt-processing overhead, and t_item the empirically measured per-item generation time under the structured format. The maximum checklist item count is set to N_max=floor((T−t_net)/t_item), the greatest integer not exceeding (T−t_net)/t_item, a monotone non-decreasing function of T; under the 30-second gateway this yields the five-item bound, and under the 120-second analysis function a bound of eight items is used in one embodiment. Bounding output length as a function of the timeout budget converts an unbounded-latency generative call into a schedulable component of a fixed-deadline pipeline. This timeout-budget-derived output-length constraint prevents gateway-timeout truncation failures of the kind described in paragraph [0009], ensuring that every structured response completes and is parseable within the allotted budget.

Resilience—circuit breaker. In one embodiment the LLM client wraps calls in a circuit breaker: five consecutive failures open the circuit; while open, calls fail fast to the deterministic fallback for 30 seconds; the circuit then transitions to half-open and admits a probe call before closing.

Resilience—retries and salvage. Transient failures (HTTP 429, 5xx, and provider-overload responses) are retried up to two times with exponential backoff. A response truncated mid-generation is passed through a salvage parser that recovers the maximal valid JSON prefix (complete checklist items already emitted are retained; the partial trailing item is dropped), so partial generations degrade to shorter checklists rather than to errors.

Resilience—deterministic fallback and degradation ladder. A hard 30-second abort applies to the model call; on abort, exhausted retries, or an open circuit, the pipeline returns the Layer 1 (and, where available, Layer 2 and Layer 3) outputs alone with a fallback flag set to true, so the user always receives the deterministic score. A graceful-degradation ladder attempts successively simpler prompt/schema versions (illustratively v3 → v2 → v1) before falling back entirely; in one deployed embodiment a synchronous workflow orchestration provides the same fallback semantics.

PHI minimization—principal embodiment. The prompt is constructed exclusively from structured non-PHI inputs: codes, amounts, dates reduced to intervals, plan attributes, state, patient age, and the deterministic layer outputs. No free-text clinical narrative, patient name, member identifier, or other direct identifier is required for checklist generation.

De-identification gate—alternative embodiment. Where free-text clinician notes are included, a de-identification gate is interposed before any external model call: a regex pre-filter removes pattern-detectable identifiers (Social Security numbers, medical record numbers, dates, phone numbers, e-mail addresses, and National Provider Identifiers), and a two-pass detection using a medical-text PHI-detection service is applied over the text in chunks (illustratively 20,000 characters with 200-character overlap so no identifier straddles a boundary undetected). If residual PHI is detected after both passes, the pipeline hard-fails the model call rather than transmitting the text; failure is preferred to exposure by design.

In some embodiments the LLM layer additionally serves a scoring-explanation function (emitting, illustratively, eight to ten explanation items across ten defined categories) under the same grounding, schema, and clamp discipline.

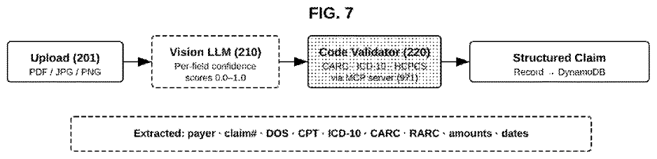

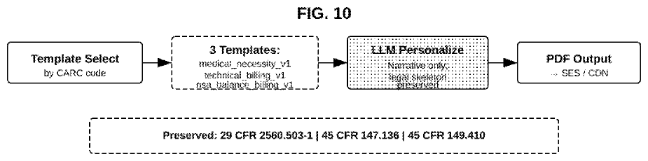

### 7. Consumer Eob Pipeline (200, 300) and Appeal Letter Generation (500) (FIGS. 7, 10, 19, 20)

In a further embodiment, a consumer pipeline accepts patient-uploaded EOB documents (PDF, JPG, or PNG), extracts structured fields via a vision-enabled LLM with per-field confidence scores, cross-validates codes against locally stored CARC, RARC, ICD-10-CM, and HCPCS Level II databases, computes an appeal viability score using Layers 1-2, generates an ordered recovery playbook (300), and produces an appeal-letter document from legal-skeleton templates (500) preserving regulatory citations.

Ingestion and extraction (200). In one embodiment the upload of a document object to the object store triggers an extraction compute function, which applies an optical-character-recognition service to the document image and then submits the recognized text (and, in vision-model embodiments, the image itself) to a model forced into a canonical extraction schema.

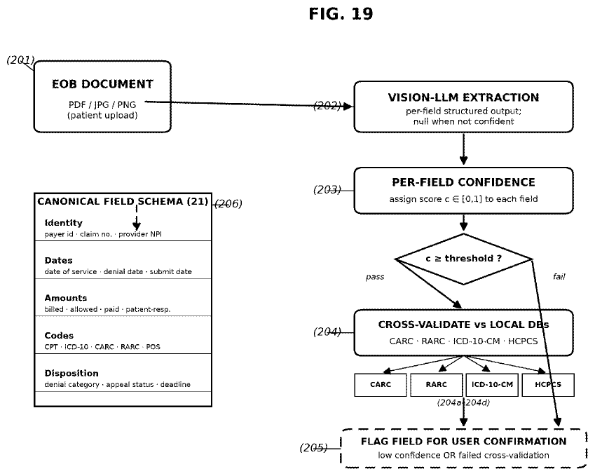

Canonical extraction schema (FIG. 19). In one illustrative embodiment the canonical schema comprises twenty-one fields, including at least: a claim identifier; the payer name; the provider National Provider Identifier; the date of service; the denial date; four monetary amounts (billed amount, allowed amount, plan-paid amount, and patient-responsibility amount); the denial reason text; the CARC code(s); the RARC code(s); the procedure code(s); the diagnosis code(s); the place of service; a denial category; an appeal status; and the appeal-rights deadline. The extraction directive instructs the model to emit null for any field it cannot confidently identify—the same null-over-guess policy as paragraph [0123]—and to emit a per-field confidence value in [0, 1] for every non-null field.

Confidence and cross-validation flow. The per-field confidences (extraction_confidences, mapping field name to [0, 1]) feed the D.1 confidence weighting of paragraph [0089], so an uncertainly extracted input is proportionally discounted in the score. Each extracted code is cross-validated against the corresponding locally stored reference database (CARC, RARC, ICD-10-CM, or HCPCS Level II); a code failing validation, or any field whose confidence falls below a threshold, is flagged for user confirmation in the interface before the pipeline proceeds. This deterministic validation stage is the propagation barrier addressing the technical problem of paragraph [0010]: no unvalidated extraction reaches a legal document.

Appeal-viability scoring and recovery playbook (300). The validated fields are scored through Layers 1-2 in Mode B. A recovery playbook generator then assembles a nine-step ordered playbook personalized with: a telephone script; a payer contact record comprising the payer's appeals mailing address, fax number, portal URL, and service-level agreement timeframes, drawn from a per-payer, per-line-of-business, per-state appeals address book; and an evidence checklist. In one embodiment a CARC-plus-RARC strategy store keyed by code pair (e.g., “CO-16_N30”) supplies, per key, a primary action, a base win probability, an evidence-needed list, and the telephone script; playbook hints include a strong-posture set (e.g., peer-to-peer review, external independent review, federal surprise-billing independent dispute resolution), required steps, and the number of days remaining before the appeal deadline.

State-law data. A fifty-state reference store supplies each jurisdiction's internal and external appeal filing windows, department-of-insurance contact information, and independent-review-organization (“IRO”) program references, which populate both the playbook and the legal-skeleton portions of the letter.

Template set (500). In one embodiment the appeal-letter template set comprises five templates, selected deterministically by CARC code: a medical-necessity template (illustratively CARCs 50, 11, 151, 57); a technical-billing template (illustratively CARCs 16, 22, 18, 45, 97,252, 109, 204); a surprise-billing template, which takes selection precedence whenever federal surprise-billing indicia are present regardless of CARC; a prior-authorization-not-obtained template (illustratively CARCs 197, 198); and a general template serving as the default. A three-template embodiment (medical-necessity, technical-billing, surprise-billing) is also disclosed.

Line-of-business regulatory citations. Each template's legal skeleton is populated with citations selected by the line of business of the denied claim, illustratively: employer-group ERISA plans—29 C.F.R. § 2560.503-1; ACA-regulated coverage—45 C.F.R. § 147.136;federal surprise-billing protections—45 C.F.R. § 149.410; Medicare Advantage—42 C.F.R. § §422.562 and 422.566; Medicaid managed care—42 C.F.R. § § 438.402 and 438.408; and traditional Medicare fee-for-service—42 C.F.R. § § 405.904 and 405.950. The skeleton further includes a notice to the applicable state department of insurance and a reference to the state's IRO program where the line of business provides external review.

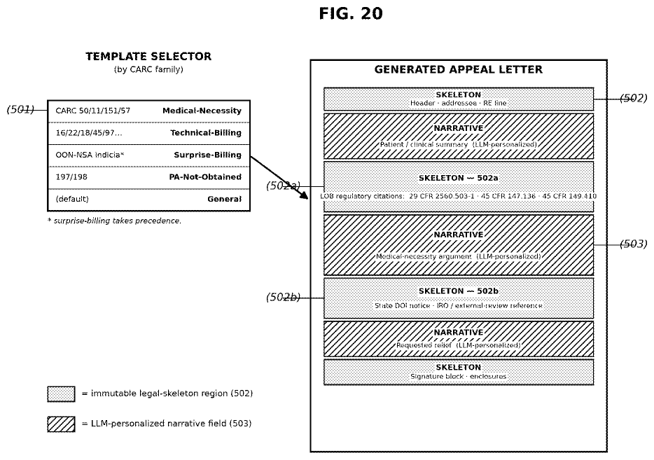

Legal-skeleton preservation mechanism (FIG. 20). Each template is stored with designated immutable regions (the legal-skeleton portions of paragraph [0052]) and designated narrative fields. The generation pipeline submits only the narrative fields to the LLM for personalization; the assembler then interleaves the returned narrative text into the template such that the immutable regions are copied byte-for-byte from the stored template into the output document. Because the LLM never receives write access to the skeleton, no hallucination, truncation, or paraphrase by the model can alter a citation, deadline notice, or statutory reference. In one embodiment the LLM's letter-generation response is itself structured as {summary, letter narrative, citations, suggested attachments, confidence, risk level, checklist}, with the citations field validated against the skeleton rather than trusted. Because assembly proceeds from the stored template's region sequence, the pipeline structurally prevents the large language model from modifying, reordering, or deleting any immutable region; in one embodiment a post-assembly comparison check verifies that every skeleton region of the output document is byte-identical to, and in the same sequence as, the corresponding region of the stored template, and rejects any generated document failing the check before delivery.

Letter structure and delivery. In one embodiment the assembled letter comprises a five-paragraph body, a documentation list, and a legal-citations block, rendered to PDF and delivered to the patient together with the recovery playbook. Uploaded EOB documents and generated letters are stored in the object store with object-level encryption at rest and a 90-day lifecycle-expiry policy, after which the objects are automatically deleted.

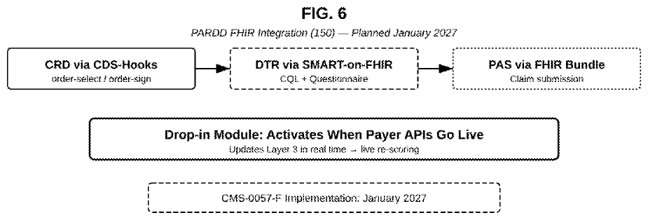

### 8. PARDD FHIR Integration (150) (FIG. 6)

In a further embodiment, when CMS-mandated payer FHIR prior-authorization APIs become operational (anticipated January 2027 per CMS-0057-F), the platform integrates a PARDD FHIR layer (150) implementing Coverage Requirements Discovery (“CRD”) via CDS-Hooks (illustratively version 2.0.1), Documentation Templates and Rules (“DTR”) via SMART-on-FHIR (illustratively version 2.0) with Clinical Quality Language (“CQL”) logic, and Prior Authorization Support (“PAS”) via a FHIR Claim Bundle. This description is prophetic as to payer-endpoint availability.

The PARDD layer is designed as a drop-in module: it remains dormant until a payer endpoint is discovered or configured, and it activates without modification to Layers 1-3,because it communicates with the deterministic stack only through the same authorization-requirement interface consulted by the Layer 3 lookup of paragraph [0119].

When active, a PAS or CRD response (for example, an authoritative statement that authorization is or is not required, or that documentation is incomplete) updates the Layer 3 denial probability in real time, replacing the lookup-table estimate for that requirement with the payer's live answer.

In one embodiment, a CDS-Hooks service presents the denial-risk score as a card at order entry (for example, on an order-select hook within an electronic health record), computed via a fast non-LLM path—Layers 1-2 only—so the card renders within interactive latency (illustratively under 500 milliseconds) inside the ordering workflow, with the full checklist analysis available on demand.

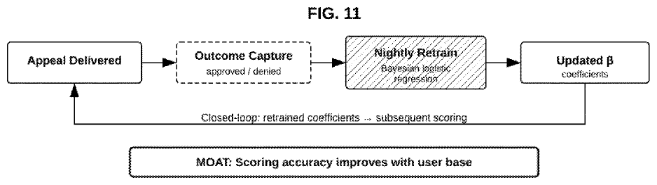

### 9. Outcome Feedback Loop (600) (FIG. 11)

In a further embodiment, the platform implements closed-loop outcome feedback (600) recording appeal outcomes {approved, partially approved, denied, withdrawn} with time-to-disposition and final allowed amount. A nightly retraining job updates per-CARC, per-payer, and per-state coefficients by Bayesian hierarchical logistic regression with shrinkage on sparse cells.

The hierarchy levels correspond to the scoring structure: a per-CARC-family base level, a per-payer (issuer-group) level, and a per-state level. Partial pooling operates as follows: a cell with abundant observations (for example, a common CARC at a large payer) is estimated substantially from its own data, while a sparse cell (for example, a rare CARC in a small state) is shrunk toward its parent level's estimate in proportion to its sparsity, so that no cell's coefficient is dominated by a handful of idiosyncratic outcomes. Shrinkage is applied whenever a cell contains fewer than a threshold number of observations.

Retrained coefficients are not applied directly to production. Each retraining run emits a candidate versioned weight set; when any retrained-coefficient shift exceeds a threshold magnitude, deployment is gated on human-in-the-loop review. Every candidate set must additionally pass the population calibration gate of paragraph [0095] before it may be promoted.

Versioned weight records. In one embodiment each weight is stored as a record keyed by a factor-cell identifier (e.g., a partition key of the form 37 F4_MA_CO-50″ identifying the F4 cell for CARC CO-50 in Medicare Advantage) and a weight-version identifier sort key, with attributes including an evidence tier, a confidence floor (feeding D.1), and a source citation identifying the evidence supporting the weight. Scoring always executes against an identified weight version, so any historical score can be reproduced exactly by replaying its version.

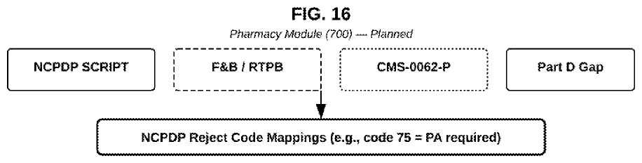

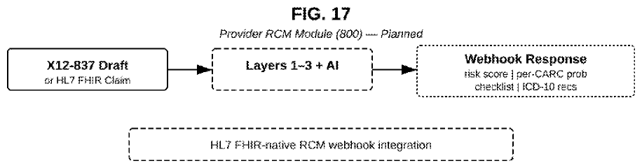

### 10. Pharmacy-benefit (700) and Provider RCM (800) Embodiments (FIGS. 16, 17)

In a further embodiment, a pharmacy module (700) adapts Layers 1-3 to the electronic prescribing, formulary-and-benefit, and real-time prescription-benefit standards of a national pharmacy-standards organization (e.g., NCPDP SCRIPT, Formulary & Benefit, and Real-Time Prescription Benefit), and to the pharmacy-benefit provisions proposed in CMS-0062-P. The scoring lookup table additionally incorporates formulary-and-benefit data and real-time prescription-benefit data, and pharmacy-claim reject codes are mapped into the F4-style reason vocabulary—for example, reject code 75, indicating that prior authorization is required, maps onto the prior-authorization reason family, and at least one generated checklist item references the reject code. This pharmacy description is prophetic as to the module's deployment.

In a further embodiment, a provider RCM module (800) exposes Layers 1-3 plus the LLM analysis layer via a webhook accepting X12-837 claim drafts or HL7 FHIR Claim resources and returning the final score, a per-CARC denial probability, and the ordered checklist, so that an RCM system can score every claim as a pre-submission pipeline step. Claim parameters are parsed from the 837 segments or FHIR resource elements into the same intrinsic-factor inputs consumed in Mode A, and the response is returned synchronously within the calling workflow's timeout budget or asynchronously via the express-workflow variant of paragraph [0062].

### 11. Worked Examples

The following two examples trace one claim through both modes. Every number in these examples—scores, rates, the modifier, and the checklist composition—is illustrative of one embodiment's calibration and one payer's published data vintage, and none is a limitation.

Worked example—pre-submission (Mode A). Inputs: CPT 27447 (total knee arthroplasty); ICD-10 M17.11; Payer A, PPO Gold plan; California; patient age 67; billed amount $45,000; prior-authorization status obtained-and-denied. Layer 1 computes the structural score at the client device, incorporating all twelve factors (including the obtained-and-denied F2contribution, the California Tier-1 F9 contribution, and the F1 log-bin for $45,000). Upon explicit user action, Layer 2 resolves Payer A's PPO line in the compiled TC-PUF lookup: plan denial rate 43.5%, plan overturn rate 47.1%, yielding a payer modifier of 0.9076. Final score=structural score×0.9076=52, banded CONTESTABLE.

Continuing the Mode A example: Layer 3 detects no NCCI conflict for the coded combination and returns auth_required_for_cpt=true for CPT 27447 under Payer A. The LLM analysis layer, invoked on explicit request, returns a structured response containing four critical and one important checklist items, including confirmation of ICD-10 laterality (M17.11 designating the right knee) and documentation of a failed six-month course of conservative treatment, each with a risk-if-skipped assessment; a projected probability if compliant lower than the headline probability; and a probability reduction in percentage points.

Worked example—post-denial (Mode B). The same claim after denial: CARC CO-50(medical necessity); 15 days since denial; a 180-day appeal deadline. The POST/score response returns: the structural score; the payer modifier 0.9076; data-source identifier “cms_tic_puf”; final score 52 (CONTESTABLE); plan denial rate 43.5%; plan overturn rate 47.1%; the per-factor decomposition listing each factor contribution; the triggered interaction rules; and warning flags, with the approaching-deadline flag false because 165 of 180 days remain—above the configurable threshold. The structural score and the payer modifier are returned as separate fields, enabling the interface to display each scoring stage's contribution independently.

### 12. Generalizations, Alternatives, and Implementation Environment

The methods described herein may be implemented on any suitable computing hardware: one or more general-purpose or special-purpose processors (CPU, GPU, or accelerator), coupled to one or more memories (volatile or non-volatile), storage devices, network interfaces, and display devices. Software implementing the described layers may be structured as monolithic applications, microservices, libraries, containers, virtual machines, or serverless compute functions, and may execute in a public cloud, a private cloud, an on-premises data center, an edge device, a mobile device, or any combination, communicating over any network including the Internet, private links, or in-process interfaces.

Any described “engine,” “layer,” “module,” “service,” or “pipeline” denotes executable logic implementing the algorithms set out in this specification, and is not a nonce term: the corresponding algorithms (the additive formula and point tables of Section 3, the modifier derivations of Section 4, the sub-scorers and edit checks of Section 5, the prompt and clamp contract of Section 6, and the extraction, validation, and assembly procedures of Section 7) constitute the structure of each such component.

The LLM genus statement of paragraph [0059] is reiterated as a generalization: nothing herein depends on a particular model vendor, model family, parameter count, hosting arrangement, or inference protocol, and “a commercial LLM API” wherever mentioned is one example alongside cloud-managed and self-hosted model services.

Scoring-location alternatives. Although the principal embodiment computes the structural score at the client device (paragraph [0065]), the same additive engine may execute server-side—for example, in the RCM webhook of paragraph [0151], where no client device participates—and a hybrid embodiment may compute at the client and verify at the server. The claims distinguish these placements expressly where the boundary is material.

Ordering variations. Layer 3 may be evaluated before, after, or concurrently with Layer 2;the deterministic layers are order-independent because Layer 2 consumes only the structural score and Layer 3 consumes only the claim parameters. The LLM layer necessarily executes last, because its prompt embeds the outputs of all deterministic layers.

Configurability. The baseline value, clip bounds, band edges, interaction-rule deltas, timeout budgets, item-count bounds, adjustment-clamp range, confidence floors, staleness thresholds, calibration-gate criteria, refresh cadence, and fallback hierarchy are each configurable parameters, and the specific values disclosed are single calibrations of one embodiment.

Security. In some embodiments all data is encrypted in transit (TLS) and at rest (object-level and record-level encryption); gateway requests are authenticated by JWT validation against the identity service; compute functions execute under least-privilege roles scoped to the specific objects, tables, and secrets they require; and the LLM credential is held exclusively in the secrets-management service and never issued to clients.

Audit logging. In some embodiments every scoring request and response—including the weight version, data-source identifier, dataset vintage, per-factor decomposition, any clamped adjustment, and any fallback flag—is written to an append-only audit log in the database service, supporting after-the-fact reconstruction of any score.

Multi-tenancy. In some embodiments the platform serves multiple tenant organizations with tenant-scoped records, tenant-time indexes, and per-tenant configuration, without alteration of the scoring architecture.

Error handling. Each layer degrades independently: a Layer 2 lookup miss falls back per paragraph [0106]; a Layer 3 reference-data miss returns the sub-scores it can compute with the missing component flagged; an LLM failure follows Section 6′s resilience ladder; and an extraction failure in the consumer pipeline flags fields for user confirmation rather than aborting. In all cases the user receives the most complete deterministic result available, with degradation flagged.

Domain generalization. Although described in terms of healthcare claim codes (CPT/HCPCS, ICD-10, CARC/RARC) and healthcare regulatory data, the disclosed architecture—a client-local additive baseline-neutral scorecard over categorical and numeric record attributes, a multiplicative modifier compiled from published counterparty-transparency data, a deterministic rule-conflict layer, and a timeout-bounded, schema-constrained, authority-clamped generative remediation layer—applies to other domains of structured-record adjudication, and the healthcare-specific vocabularies are, in the broadest embodiments, one instantiation of the described data-processing architecture.

The individual features of the embodiments described above may be combined, omitted, or reordered except where this specification states otherwise, and the invention is defined by the claims rather than by any embodiment.

What is claimed is:

1. A computer-implemented method performed by a server system for pre-submission healthcare-claim denial-risk analysis, the method comprising:
serving, by the server system to a client device, scoring logic and a factor point-table data set that, when executed at the client device, cause the client device to compute, locally at the client device and without transmitting claim-identifying parameters of a healthcare claim to the server system, a structural denial-risk score by additively combining a baseline value with a respective signed point contribution for each of a plurality of intrinsic claim factors, wherein an unknown or missing input for any of the intrinsic claim factors contributes exactly zero points such that the structural denial-risk score is computable from any single available input, each said respective signed point contribution being retrieved from the factor point-table data set by table lookup and the structural denial-risk score being computed without generating any learned embedding of the intrinsic claim factors and without applying, at scoring time, any model trained on historical claim-outcome labels, and wherein the structural denial-risk score is clipped to a bounded range;
compiling, by the server system, a scoring lookup table from publicly published issuer-level payer-transparency data comprising at least an issuer-level plan denial rate and an issuer-level appeal overturn rate;
in response to a scoring request from the client device that identifies an issuer without conveying the claim-identifying parameters, retrieving, by the server system from the scoring lookup table, an issuer-specific payer modifier and transmitting the issuer-specific payer modifier to the client device for multiplicative application to the structural denial-risk score to produce a final score clipped to the bounded range and assigned to one band of a predetermined set of bands;
performing, by the server system, a deterministic edit analysis comprising National Correct Coding Initiative (NCCI) edit-conflict detection and a per-procedure-code, per-payer prior-authorization-requirement lookup, and generating therefrom a denial probability and a categorical warning distinct from the denial probability;
responsive to an explicit user action received after the final score is displayed at the client device, constructing, by the server system, a prompt comprising the structural denial-risk score, the issuer-specific payer modifier, the denial probability, and an output of the NCCI edit-conflict detection, the prompt including (i) a grounding directive constraining a large language model to information contained in the prompt, (ii) a directive constraining output of the large language model to a structured machine-readable format, and (iii) an output-length constraint computed by the server system as a function of a timeout budget of an intermediary gateway such that a response of the large language model completes within the timeout budget and truncation of the response by the intermediary gateway is prevented;
submitting the prompt to the large language model and receiving therefrom a structured response comprising a diagnosis-code specificity recommendation, an ordered checklist of pre-submission remediation items, each item of the ordered checklist carrying a priority level and a risk-if-skipped assessment; and
transmitting, by the server system, the denial probability, the categorical warning, and the ordered checklist to the client device for display.

2. The method of claim 1, wherein the bounded range is from 5 to 100, the baseline value is 50,and the predetermined set of bands comprises a first band from 70 to 100, a second band from 45to 69, a third band from 20 to 44, and a fourth band from 5 to 19.

3. The method of claim 1, wherein the intrinsic claim factors comprise a claim-adjustment-reason-code-by-line-of-business matrix lookup over a matrix of at least twelve claim-adjustment-reason-code families crossed with at least six line-of-business types, and wherein, when the healthcare claim bears a plurality of claim-adjustment-reason codes, the matrix lookup selects a worst-scoring cell as a primary contribution while preserving remaining codes as secondary contributions.

4. The method of claim 1, wherein the structural denial-risk score is further adjusted by at least eight cross-factor interaction rules, each applying a respective signed adjustment when a specified combination of values of two or more of the intrinsic claim factors co-occurs, the interaction rules including at least a rule applying a positive offset when a network status indicates an out-of-network provider at an in-network facility eligible for federal surprise-billing protection.

5. The method of claim 1, wherein the scoring logic applies confidence-weighted point contributions in which each point contribution is scaled by a confidence value having a tier-specific floor, applies a logarithmic tail to point contributions for claim dollar amounts above a threshold, associates each scoring weight with a provenance date and sets an evidence-freshness flag when highest-tier evidence supporting the weight exceeds a staleness threshold, and wherein the server system blocks deployment of any scoring-weight set that fails a population calibration gate evaluated against a synthetic claim population.

6. The method of claim 1, wherein the output-length constraint limits the ordered checklist to a maximum number of items, the maximum number being computed as a function of the timeout budget of the intermediary gateway.

7. The method of claim 1, wherein the NCCI edit-conflict detection comprises detection of procedure-to-procedure edit conflicts, medically-unlikely-edit violations, and add-on-code edit violations, and wherein a detected conflict causes a first item of the ordered checklist to address the detected conflict.

8. The method of claim 1, wherein the structured response further comprises a projected probability if compliant, constrained by the prompt to be less than the denial probability, and a probability reduction expressed in percentage points achievable by completing the ordered checklist.

9. The method of claim 1, further comprising invoking, by the server system via a FHIR-based prior-authorization transaction stack, at least one of (i) coverage-requirements discovery via a CDS-Hooks invocation, (ii) documentation templates and rules via a SMART-on-FHIR questionnaire driven by Clinical Quality Language logic, and (iii) prior-authorization support via a FHIR Claim bundle, and updating the denial probability based on a response received via the FHIR-based prior-authorization transaction stack.

10. The method of claim 1, wherein the method is performed as a pre-submission step of a revenue-cycle-management workflow by receiving claim parameters as an X12-837 claim draft or an HL7 FHIR Claim resource via a webhook and returning the final score, the denial probability, and the ordered checklist to the revenue-cycle-management workflow.

11. A computer-implemented method performed by one or more processors of a computing system for post-denial appeal-viability scoring, the method comprising:
receiving claim parameters of an existing denied healthcare claim, the claim parameters including at least an issuer identifier, a claim-adjustment-reason code, a procedure code, a billed amount, a state identifier, a network status, an emergency status, a prior-authorization status, and a number of days since denial;
computing a structural score for the denied healthcare claim by additively combining a baseline value with a respective signed point contribution for each of a plurality of intrinsic claim factors, wherein an unknown or missing input contributes exactly zero points such that the structural score is computable from any single available input, each said respective signed point contribution being retrieved by table lookup from a stored factor point-table data set and the structural score being computed without applying, at scoring time, any machine-learning model trained on historical claim-outcome labels;
retrieving, from a scoring lookup table compiled from publicly published issuer-level payer-transparency data, an issuer-specific payer modifier, an issuer-specific plan denial rate, and an issuer-specific appeal overturn rate for the issuer identified by the issuer identifier;
computing a final appeal-viability score by applying the issuer-specific payer modifier as a multiplicative adjustment to the structural score and clipping the final appeal-viability score to a bounded range, and assigning the final appeal-viability score to one band of a predetermined set of bands; and
outputting, for display, the final appeal-viability score, said one band, the issuer-specific plan denial rate, the issuer-specific appeal overturn rate, a data-source identifier indicating the payer-transparency data from which the issuer-specific payer modifier was derived, a per-factor decomposition identifying the point contribution of each intrinsic claim factor, an identification of any triggered cross-factor interaction, and at least one warning flag, wherein the structural score and the issuer-specific payer modifier are output as separate fields enabling independent display of a contribution of each scoring stage.

12. The method of claim 11, wherein the issuer-specific payer modifier is derived as a function of a ratio of the issuer-specific plan denial rate to a baseline denial rate computed from the payer-transparency data, the scoring lookup table being recompiled on a periodic schedule from updated releases of the payer-transparency data.

13. The method of claim 11, wherein a surprise-billing adjustment is applied when the claim parameters indicate emergency services or an out-of-network provider at an in-network facility and a date of service on or after Jan. 1, 2022, and wherein the at least one warning flag comprises an approaching-appeal-deadline flag triggered when a number of days remaining before an appeal deadline falls below a configurable threshold.

14. The method of claim 11, wherein the claim parameters are obtained by: receiving an explanation-of-benefits document uploaded in an image or portable-document format; extracting, via a vision-enabled machine-learning model, a plurality of structured fields from the Explanation-of-Benefits document, each extracted field being assigned a per-field confidence score and being set to a null value when uncertain; cross-validating each extracted code against at least one locally stored code-reference database; and flagging for user confirmation any extracted field whose per-field confidence score is below a threshold or whose cross-validation fails.

15. The method of claim 14, further comprising:
selecting, as a selected template, one appeal-letter template from a template set comprising at least a medical-necessity template, a technical-billing template, and a surprise-billing template based on the claim-adjustment-reason code;
generating an appeal-letter document by personalizing designated narrative fields of the selected template via a large language model while a machine-generation pipeline structurally prevents the large language model from modifying, reordering, or deleting immutable legal-skeleton portions of the selected template, the immutable legal-skeleton portions being copied byte-for-byte from the selected template into the appeal-letter document and including regulatory citations selected according to a line of business of the denied healthcare claim; and
delivering the appeal-letter document together with an ordered recovery playbook.

16. A system for dual-mode healthcare claim denial intelligence, the system comprising one or more hardware processors and one or more non-transitory computer-readable memories storing instructions that, when executed by the one or more hardware processors, cause the system to:
provide a shared denial scoring engine, comprising the one or more hardware processors executing stored scoring instructions, operable in (i) a pre-submission mode outputting a denial-risk score with an ordered remediation checklist and (ii) a post-denial mode outputting an appeal-viability score with an issuer-specific plan denial rate and appeal overturn rate, both modes additively combining a baseline value with signed point contributions of a plurality of intrinsic claim factors, each said signed point contribution being retrieved by table lookup from a stored factor point-table data set, wherein an unknown or missing input contributes exactly zero points;
maintain a scoring lookup table compiled from publicly published issuer-level payer-transparency data, and apply a retrieved issuer-specific payer modifier as a multiplicative adjustment clipped to a bounded range;
execute a deterministic analysis engine, comprising the one or more hardware processors executing stored deterministic-analysis instructions, performing NCCI edit-conflict detection and per-procedure-code, per-payer prior-authorization-requirement lookup;
submit, responsive to receipt of an explicit user invocation received after the denial-risk score or the appeal-viability score is displayed, a prompt to a large language model, the prompt including a grounding directive, a structured-output directive, and an output-length constraint computed as a function of a timeout budget of an intermediary gateway, and refrain from submitting the prompt absent receipt of the explicit user invocation;
receive, from the large language model, a structured response.

17. The system of claim 16, wherein the instructions further cause the system to: record, for scored claims, outcome labels selected from approved, partially approved, denied, and withdrawn, together with a time-to-disposition; retrain, by a Bayesian hierarchical logistic regression with shrinkage applied to any cell having fewer than a threshold number of observations, coefficients comprising at least a per-claim-adjustment-reason-code factor, a per-payer factor, and a per-state factor, thereby producing retrained coefficients; apply the retrained coefficients to the scoring lookup table; and require a human-in-the-loop review before deployment when a retrained-coefficient shift exceeds a threshold magnitude.

18. The system of claim 16, wherein the shared denial scoring engine executes client-side within a web browser without transmitting claim-identifying parameters to a server, and wherein a server-side token-proxy function resolves a browser cross-origin restriction by proxying an authentication-token request to an identity service and returning a token with cross-origin response headers.

19. One or more non-transitory computer-readable media storing instructions that, when executed by a server system, cause the server system to perform operations comprising: serving, to a client device, scoring logic and a factor point-table data set causing the client device to compute, locally and without transmitting claim-identifying parameters to the server system, a structural denial-risk score additively combining a baseline value with signed point contributions of a plurality of intrinsic claim factors, each said signed point contribution being retrieved by table lookup from the factor point-table data set without applying, at scoring time, any model trained on historical claim-outcome labels, an unknown or missing input contributing exactly zero points; retrieving, from a scoring lookup table compiled from publicly published issuer-level payer-transparency data, an issuer-specific payer modifier for multiplicative application to the structural denial-risk score; performing a deterministic edit analysis comprising NCCI edit-conflict detection and per-procedure-code, per-payer prior-authorization-requirement lookup to generate a denial probability; responsive to an explicit user action received after a resulting score is displayed, submitting to a large language model a prompt including a grounding directive, a structured-output directive, and an output-length constraint computed as a function of a timeout budget of an intermediary gateway, such that a response of the large language model completes within the timeout budget and truncation of the response by the intermediary gateway is prevented; and receiving, from the large language model, a structured response.

20. The method of claim 1, wherein the scoring request further conveys the structural denial-risk score as a numeric value without conveying any of the claim-identifying parameters, and wherein the method further comprises computing, by the server system, the final score by multiplicatively applying the issuer-specific payer modifier to the structural denial-risk score conveyed by the scoring request, clipping the final score to the bounded range, assigning the final score to said one band of the predetermined set of bands, and transmitting the final score and said one band to the client device for display.

21. The method of claim 8, wherein the structured response further comprises any proposed numeric score adjustment of the large language model, the method further comprising clamping, by the server system, any proposed numeric score adjustment received from the large language model to a bounded adjustment range of plus-or-minus five points, prior to any application of the proposed numeric score adjustment, such that the large language model is structurally prevented from overriding the structural denial-risk score, the issuer-specific payer modifier, or the denial probability, and wherein the server system rejects any structured response in which the projected probability if compliant is not less than the denial probability.

22. The method of claim 6, wherein the maximum number of items is computed as the floor of (T−t_net)/t_item, where T is the timeout budget of the intermediary gateway, t_net is a budgeted network and prompt-processing overhead, and t_item is a measured per-item generation time under the structured machine-readable format, and wherein a timeout budget of thirty seconds yields a maximum of five items.

23. The method of claim 1, wherein each entry of the scoring lookup table stores a data-source identifier and a data-vintage identifier of the payer-transparency data from which the entry was compiled, and wherein retrieving the issuer-specific payer modifier is conditioned on the data-vintage identifier of the entry from which the issuer-specific payer modifier is retrieved satisfying a recency threshold, and wherein, when no entry for the issuer satisfies the recency threshold, the issuer-specific payer modifier is resolved through a hierarchical fallback terminating at a benchmark modifier.

24. The method of claim 11, wherein each entry of the scoring lookup table stores a data-vintage identifier of the payer-transparency data from which the entry was compiled, wherein retrieving the issuer-specific payer modifier is conditioned on the data-vintage identifier of the entry from which the issuer-specific payer modifier is retrieved satisfying a recency threshold, wherein, when no entry for the issuer identified by the issuer identifier satisfies the recency threshold, the issuer-specific payer modifier is resolved through a hierarchical fallback proceeding from a payer-state-procedure-code level, to an issuer-state level, to an issuer-national level, to a state benchmark, and terminating at a national benchmark, and wherein the outputting further identifies which level of the hierarchical fallback the issuer-specific payer modifier was retrieved from.

25. The system of claim 16, wherein each entry of the scoring lookup table stores a data-source identifier and a data-vintage identifier, and wherein the instructions further cause the system to condition retrieval of the issuer-specific payer modifier on the data-vintage identifier of a corresponding entry of the scoring lookup table satisfying a recency threshold.

26. The method of claim 11, wherein each entry of the scoring lookup table stores a data-source identifier and a data-vintage identifier of the payer-transparency data from which the entry was compiled, wherein the structural score and the issuer-specific payer modifier are output as separately addressable fields each accompanied by the data-source identifier and the data-vintage identifier of the entry from which the issuer-specific payer modifier was retrieved, and wherein the per-factor decomposition identifies, for each intrinsic claim factor, whether the point contribution of that factor was derived from an available input or was held at exactly zero for an unknown or missing input.

27. The method of claim 1, wherein the categorical warning is selected from an enumerated set of warning categories, is carried in a data field separate from a field carrying the denial probability, and is generated by the deterministic edit analysis independently of the denial probability and of any output of the large language model.

28. The method of claim 15, wherein a post-assembly comparison check verifies that every immutable legal-skeleton portion of the appeal-letter document is byte-identical to, and in the same sequence as, the corresponding portion of the selected template, and wherein any appeal-letter document failing the comparison check is rejected before delivery.

29. The method of claim 11, wherein the final appeal-viability score is computed without applying any machine-learning model trained to predict whether a denial of the denied healthcare claim will be overturned on appeal, the method further comprising: selecting, as a selected template, an appeal-letter template based on the claim-adjustment-reason code; generating an appeal-letter document by personalizing designated narrative fields of the selected template via a large language model while immutable legal-skeleton portions of the selected template are copied byte-for-byte into the appeal-letter document; and verifying, after assembly, that each immutable legal-skeleton portion of the appeal-letter document is byte-identical to, and in the same sequence as, the corresponding portion of the selected template, the appeal-letter document being rejected upon any deviation.

30. The system of claim 16, wherein the pre-submission mode and the post-denial mode consult the same scoring lookup table, and wherein the structured response includes any proposed numeric score adjustment of the large language model, any such proposed numeric score adjustment being clamped to a bounded adjustment range that is the same in the pre-submission mode and in the post-denial mode.
